(19) United States
(12) Patent Application Publication
(10) Pub. No.: US 2008/0068579 A1
(43) Pub. Date: Mar. 20, 2008

(54) APERTURE UNIT AND EXPOSURE SYSTEM INCLUDING THE SAME, AND METHOD FOR REPLACING APERTURES OF THE APERTURE UNIT

(75) Inventor: Dong-Kyeng HAN, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/855,967

(22) Filed: Sep. 14, 2007

(30) Foreign Application Priority Data
Sep. 14, 2006 (KR) 10-2006-89332

(51) Int. Cl. G03B 27/72; G02B 26/02

(52) U.S. Cl. 355/71; 359/234

(57) ABSTRACT

Provided are an aperture unit, an exposure system including the aperture unit, and a method for replacing an aperture of the aperture unit. The aperture unit rotates a revolver on which a plurality of apertures is installed, in order to selectively dispose an aperture in an optical path and convert light emitted onto a reticle into various shapes. The apertures installed on the revolver are removed by a conveying unit and loaded onto a cassette. Other apertures loaded on the cassette are installed on the revolver by means of the conveying unit. A housing is provided in the optical path to enclose the aperture unit, revolver, conveying unit, and cassette. The housing isolates a path of movement for the aperture conveyed between the revolver and the cassette from the outside.

### CROSS-REFERENCE TO RELATED APPLICATIONS

This U.S. non-provisional patent application claims priority under 35 U.S.C. § 119 of Korean Patent Application No. 10-2006-89332, filed on Sep. 14, 2006, the entire contents of which are hereby incorporated by reference.

### BACKGROUND OF THE INVENTION

The present invention disclosed herein relates to an aperture unit capable of changing the form of incident light in a variety of ways, and more particularly, to an aperture unit capable of easily replacing apertures.

A photolithography process is performed to form a photoresist pattern on a layer. The layer is formed on a semiconductor substrate through a deposition process in order to make the layer into a pattern having specific electrical characteristics. The photoresist pattern is used as a mask in an etching process for forming the pattern.

Such a photolithography process includes an exposing process. In the latter, a reticle is used to form a photoresist pattern from a photoresist layer on a semiconductor substrate.

Recently, as the integration of semiconductor devices increases, the size of patterns formed on semiconductor substrates gradually decreases, so that the resolution and Depth of Focus (DOF) in a photolithography process become more crucial. The resolution and DOF vary depending on the wavelength of light and the Numerical Aperture (NA) of a projection lens used in the exposing process.

One drawback is that when the NA of a projection lens is increased in order to increase resolution, the DOF decreases. Off-axis illumination is used to avert the above limitation, and is a method of increasing the DOF by emitting 0^{th} and a 1^{st} light beam from a light beam diffracted by the retical.

Off-axis illumination includes annular illumination, dipole illumination, and quadrupole illumination. As an example of off-axis illumination, a projection lithography system that provides a quadrupole illumination pattern is disclosed in U.S. Pat. No. 6,388,736, which is hereby incorporated by reference.

In order to obtain the best resolution and optimum DOF using off-axis illumination, an aperture is provided that has a shape suitable for the pattern laid out on the reticle. That is, a desired pattern on a wafer is formed and a high resolution and optimum DOF are achieved when light of a suitable direction and energy is incident according to the size, shape, gaps, etc. of the pattern laid out on the reticle.

In modern integrated circuit fabrication processes, between 20 and 30 sheets of reticles with different pattern shapes are required to fabricate one device. Unfortunately, every time a new reticle is needed for the next step in the process, it is likely that the equipment must be stopped to replace the aperture plate associated with the reticle. This downtime severely lengthens the manufacturing time.

Accordingly, the efficient replacement and presentation of the next aperture plate in the process is highly desired.

### SUMMARY OF THE INVENTION

The present invention provides an aperture unit and an aperture replacing method capable of facilitating the replacing of an aperture in an optical path to one of a desired shape or pattern.

The present invention also provides an aperture unit and an aperture replacing method capable of shortening the time it takes to replace an aperture.

The present invention further provides an aperture unit and an aperture replacing method capable of providing an aperture with a suitable shape according to a pattern laid out on a reticle, in order to achieve a high resolution and an optimum depth of focus.

Embodiments of the present invention provide aperture units including: a cassette on which apertures are loaded, the apertures disposed in an optical path to convert a form of incident light in various ways; a revolver including a plurality of slots formed about a rotating axis of the revolver for installing the apertures respectively in, the revolver for rotating and selectively positioning the apertures in the optical path; and a conveying unit for conveying the apertures from the cassette and installing the apertures in the slots.

In some embodiments, the slots may be recessed from an outer perimeter of the revolver toward a center of the revolver, and the apertures may be inserted into the slots.

In other embodiments, guide rails may be formed on side surfaces of the slots, guide slots into which the guide rails are inserted may be formed in side surfaces of the apertures, and the apertures may be installed in predetermined positions along the guide rails.

In still other embodiments, the side surfaces of the slots may have guide slots formed therein, guide rails that insert in the guide slots may be formed in side surfaces of the apertures, and the apertures may be installed along the guide rails to a predetermined position.

In even other embodiments, the aperture unit may further include a housing for isolating a moving path of the aperture from the cassette to the revolver from an outside, wherein the cassette, the revolver, and the return unit may be provided within the housing.

In other embodiments of the present invention, exposure systems including: a light source for emitting light; an illumination part for transmitting the light emitted from the light source toward a reticle; and a projection part for radiating light transmitted through the reticle onto a substrate loaded on a substrate stage; wherein the illumination part includes an aperture unit provided in an optical path, the aperture unit for adjusting a coherence factor (σ) of incident light, the aperture unit having: a cassette on which apertures are loaded, the apertures disposed in an optical path to convert a form of incident light in various ways, a revolver including a plurality of slots formed about a rotating axis of the revolver for installing the apertures respectively in, the revolver for rotating and selectively positioning the apertures in the optical path, and a conveying unit for conveying the apertures from the cassette and installing the apertures in the slots.

In yet other embodiments, the slots may be recessed from an outer perimeter of the revolver toward a center of the revolver, and the apertures may be inserted into the slots.

In further embodiments, guide rails are formed on side surfaces of the slots, guide slots into which the guide rails are inserted are formed in side surfaces of the apertures, and the apertures are installed in predetermined positions along the guide rails.

In still further embodiments, the side surfaces of the slots may have guide slots formed therein, guide rails that insert in the guide slots may be formed in side surfaces of the apertures, and the apertures may be installed along the guide rails to a predetermined position.

In even further embodiments, the exposure system may further include a housing for isolating a moving path of the aperture from the cassette to the revolver from an outside, wherein the cassette, the revolver, and the return unit may be provided within the housing.

In still other embodiments of the present invention, methods for replacing apertures installed on a rotatable revolver, the apertures disposed in an optical path, for converting incident light into various shapes according to a rotation of the revolver, the methods including: separating the apertures on the revolver using a conveying unit, and loading the separated apertures on a cassette; and installing another aperture loaded on the cassette onto the revolver, using the conveying unit.

In even other embodiments of the present invention, the cassette, the revolver, and the conveying unit may be provided within a housing disposed in the optical path, and the housing may isolate a moving path of the aperture.

In yet other embodiments of the present invention, the aperture may be inserted into a slot recessed from an outer circumference of the revolver toward a center of the revolver.

In further embodiments of the present invention, the slot may include a guide rail formed on a side surface thereof, and the aperture may include a guide slot formed in a side surface thereof for inserting the guide rail, the guide slot for sliding along the guide rail to install the aperture into the slot.

In still further embodiments of the present invention, the slot may include a guide slot formed in a side surface thereof, the aperture may include a guide rail formed on a side surface thereof, the guide rail for inserting into the guide slot, and the guide rail may slide along the guide slot to install the aperture into the slot.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a schematic diagram of an exposure system according to the present invention;

FIG. 2 is a schematic diagram of an aperture unit according to the present invention;

FIG. 3 is a perspective view of a revolver according to the first embodiment of the present invention;

FIG. 4 is a perspective view of an aperture according to the first embodiment of the present invention;

FIGS. 5a and 5b are a plan view and a side view showing the assembly of the revolver in FIG. 3 and the aperture in FIG. 4;

FIG. 6 is a perspective view of a revolver according to the second embodiment of the present invention;

FIG. 7 is a perspective view of an aperture according to the second embodiment of the present invention; and

FIGS. 8a and 8b are a plan view and a side view showing the assembly of the revolver in FIG. 6 and the aperture in FIG. 7.

### DETAILED DESCRIPTION OF PREFERRED EMBODIMENTS

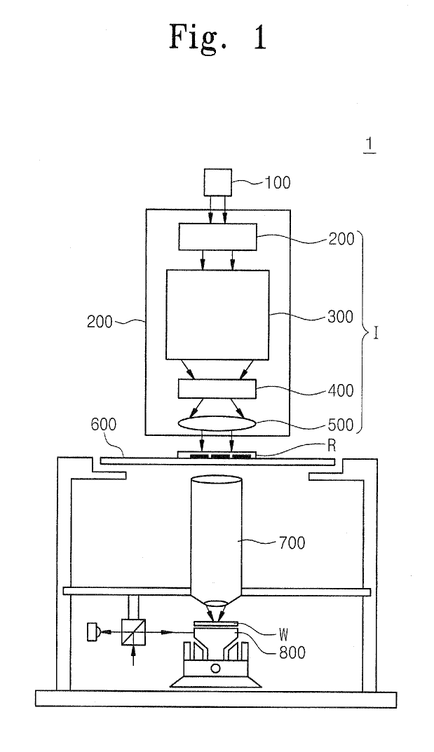

Preferred embodiments of the present invention will be described below in more detail with reference to FIGS. 1 through 8b. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the figures, the dimensions of the respective elements shown in the drawings may be exaggerated for clarity of illustration.

Hereinafter, an exemplary embodiment of the present invention in conjunction with the accompanying drawings will be described.

While the functions of respective elements of an exposure system 1 made by different manufacturers may generally be the same, the arrangement or order of elements disposed according to an optical path and the respective operating principles of each element may differ slightly. Therefore, in the description of an exposure system 1 below, the functions of the elements will be stressed, while the arrangement of the elements may be varied.

The exposure system 1 described below is disclosed in detail by Nikon Corp. in U.S. Pat. No. 6,331,885 (issued to Nishi) and in U.S. Pat. No. 6,538,719 (issued to Takahashi, et al.), and in Korean Patent Registration No. 10-0571371 disclosed by ASML, which are all hereby incorporated by reference. Since the functions of the components of the exposure system 1 are already well known to those skilled in the art, detailed descriptions of the components will not be given.

Also, while the substrate in the below description is exemplified by a wafer W, the present invention is not limited thereto.

FIG. 1 is a schematic diagram of an exposure system 1 according to the present invention.

A wafer W is mounted on a wafer stage 800. A photoresist layer (not shown) is formed on the wafer W, and a photoresist pattern is formed through performing an exposing process and a developing process using the photoresist layer. The photoresist layer is formed on the wafer W through a photoresist coating process and a soft bake process, and the photoresist pattern formed using these processes may be used as a mask for etching layers therebelow or as a mask for use in an ion implantation process.

A plurality of shot regions are installed on the wafer W, where each shot region includes at least one die region. The size of a die region may vary depending on the type of semiconductor device required, and the sizes of each shot region and the number of shot regions may be determined according to the size of the die regions.

An exposure system 1 includes a light source 100, an illumination part (I), a mask stage 600, a projection part 700, and a wafer stage 800.

The light source 100 generates light for exposure. The light source 100 may include a mercury lamp, an ArF laser generator, a KrF laser generator, and an extreme ultraviolet or electron beam generator. The light source 100 is connected to the illumination part (I).

The illumination part (I) transmits light generated by the light source 100 onto a reticle R. Here, the light generated in the form of point light by the illumination part (I) is converted to surface light and transmitted to the reticle R at a certain-sized contact region thereon.

The illumination part (I) includes a light distribution control unit 200, an aperture unit 300, a blind unit 400, and a condenser lens 500.

The light distribution control unit 200 increases the uniformity of light generated by the light source 100. The aperture unit 300 adjusts the coherence factor (σ) of light. The blind unit 400 blocks a portion of light and regulates the illuminated region of the reticle R. Thus, during exposure, the blind unit 400 is used to limit the illuminated region, preventing exposure of other regions not requiring exposure. The condenser lens 500 provides a uniform intensity distribution of incident light, and light that passes through the condenser lens 500 is transmitted onto a preset illumination region of the reticle R.

The light generated by the light source 100 passes through the illumination part (I) so that it is in a state suitable for forming a photoresist pattern on a wafer W. Here, what is meant by ‘suitable’ is light that is of a certain quantity, intensity, density, etc. that corresponds to the characteristics of the photoresist pattern. Those skilled in the art will be able to easily select conditions suitable for the aspect ratio, etching selection ratio, etc. of fine structures to be formed on a wafer W.

Light that passes through the illumination part (I) is illuminated on the reticle R disposed on the reticle stage 600. A plurality of circuit patterns for projecting onto the shot regions of the wafer W are formed on the reticle R. The light transmitted to the reticle R passes through the reticle R and reflects the image data of the circuit patterns. Here, the reticle R may be moved in a predetermined direction by the reticle stage 600.

The light that passes through the reticle R is transmitted to the projection part 700. The projection part 700 transmits the light reflecting the image data of the circuit patterns onto the wafer W at multiple focal points, and performs a focus latitude extended exposure (FLEX) process. FLEX is a technology in which a circuit pattern image of a reticle R is transmitted onto a wafer at various superposed focal points, so that not only can the margin for image formation be increased, but the depth of focus (DOF) can also be increased. The projection part 700 has an overall cylindrical shape, of which the upper end is directed toward the reticle R and the lower end is directed toward the wafer W.

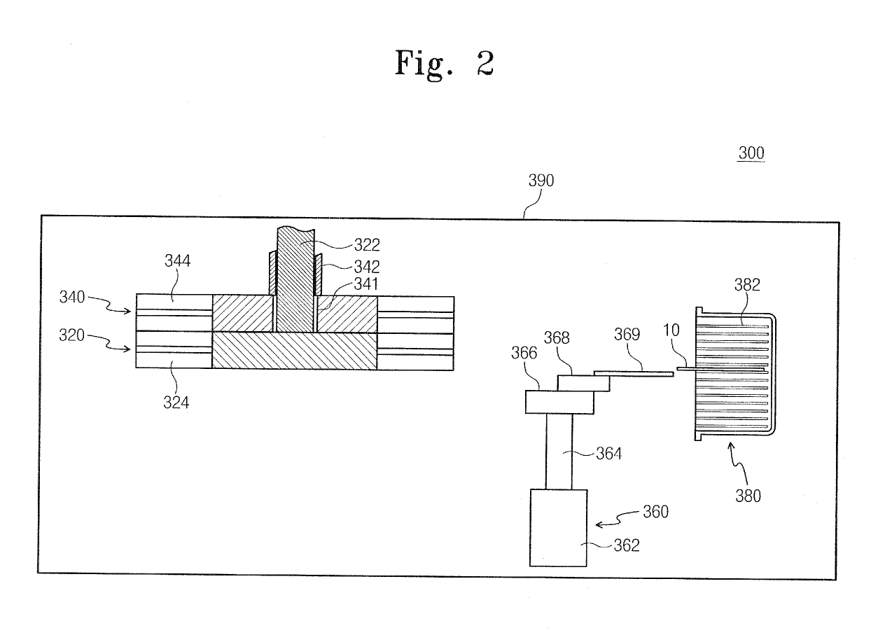

FIG. 2 is a schematic diagram of an aperture unit 300 according to the present invention.

As described above, the form of light incident on the aperture unit 300 is converted to adjust the coherence factor (σ) of the light. The aperture unit 300 converts the form of light into an annular or quadruple form.

The aperture unit 300 includes a first and second revolver 320 and 340 and a cassette 380, and a conveying unit 360 disposed between the first and second revolvers 320 and 340 and the cassette 380.

The first revolver 320 and the second revolver 340 are superimposed with a predetermined gap therebetween. The first revolver 320 is connected at its upper surface to a first rotating shaft 322, and the first revolver 320 is rotated by the first rotating shaft 322. Likewise, the second revolver 340 is connected at its upper surface to a second rotating shaft 342, and the second revolver 340 is rotated by the second rotating shaft 342. The second rotating shaft 342 is a hollow shaft, and the first rotating shaft 322 is installed within the second rotating shaft 342. The first rotating shaft 322 passes through the inside of the second rotating shaft 342 and a through hole 341 formed in the center of the second revolver 340, and is connected to the upper surface of the first revolver 320.

A plurality of first slots 324, on which an aperture 10 (to be described below) is installed, is formed around the perimeter of the first revolver 320, and a plurality of second slots 344, on which the aperture 10 is installed, is formed around the perimeter of the second revolver 344.

The cassette 380 is provided to a side of the first and second revolvers 320 and 340. A plurality of apertures 10 for the above-described off-axis illumination is loaded in various ways on the cassette 380, and the form of light is converted to an annular, dipole, or quadrupole type form according to the type of aperture 10. A plurality of slots 382 is provided on the cassette for loading the apertures 10.

The conveying unit 360 is installed between the first and second revolvers 320 and 340 and the cassette 380. The conveying unit 360 either removes apertures 10 installed in the first and second slots 324 and 344 to load them on the cassette 380, or installs apertures 10 loaded on the cassette 380 in the first or second slots 324 and 344.

The conveying unit 360 includes a driver 362 generating driving force, a drive shaft 364 connected perpendicularly to the lower end of the driver 362, a first arm 366 connected to the upper end of the drive shaft 364, a second arm 368 connected to the upper end of the first arm 366, and a hand 369 connected to the second arm 368.

The hand 369 holds the apertures 10. The apertures 10 held by the hand 369 are moved to desired positions by the first and second arms 366 and 368. The first and second arms 366 and 368 are a type of linking device, and are capable of rotating relative to each other. The second arm 368 is capable of rotating with respect to the drive shaft 364, and the apertures 10 may be moved freely by the first and second arms 368 within the same plane. The height of the head 369 may be controlled by elevating the drive shaft 364.

The aperture unit 300 further includes a housing 390. The housing 390 is provided in the optical path, encloses the first and second revolvers 320 and 340 and the cassette 380, and also functions to isolate a path of movement for a returned aperture 10 between the first and second revolvers 320 and 340 and the cassette 380. The housing 390 is provided together with a separate housing that encloses the light distribution control unit 200 or the blind unit 400, and separately seals the moving path of the aperture 10 in order to prevent contamination of the aperture 10.

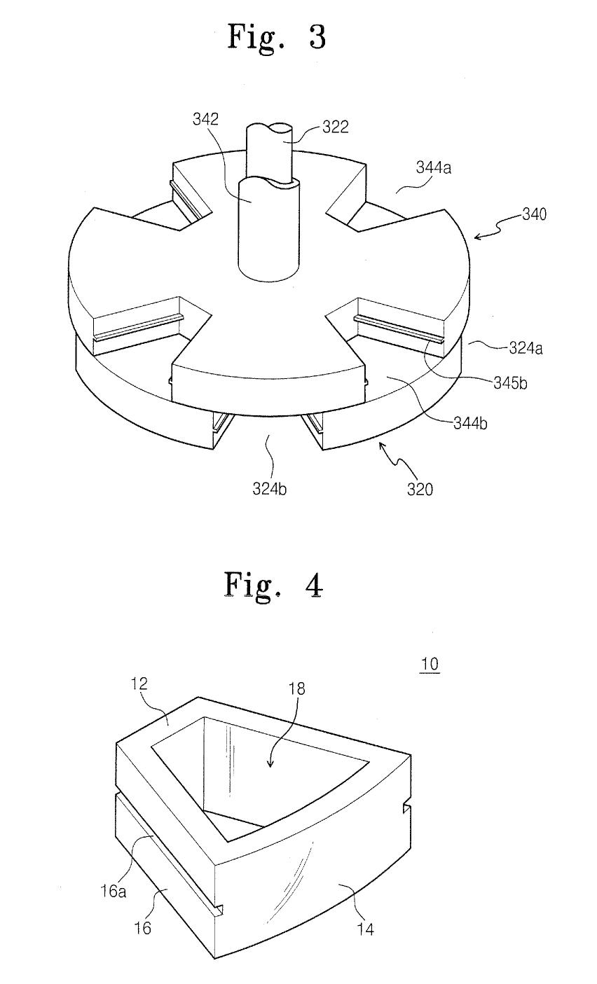

FIG. 3 is a perspective view of a revolver according to the first embodiment of the present invention.

The first revolver 320 has four first slots 324 that include one normal slot 324a and three installing slots 324b. The normal slot 324a does not have an aperture 10 installed therein, and the installing slots 324b are slots in which apertures 10 are installed. Also, the second revolver 340 has four second slots 344 that include one normal slot 344a and three installing slots 344b. Similarly, the normal slot 344a does not have an aperture 10 installed therein, while the installing slots 344b have apertures installed therein.

The first and second revolvers 320 and 340 are used in collaboration. For example, when an aperture 10 is to be used while installed in an installing slot 324b of the first revolver 320, the installing slot 324b in which the aperture 10 is installed and the normal slot 344a of the second revolver 340 are aligned in the optical path, so that the incident light passes through the aperture 10 and the normal slot 344a aligned in the optical path, whereby the light is converted only by the aperture 10. When an aperture 10 installed in an installing slot 344b of the second revolver 340 is to be used, the installing slot 344b with the aperture installed therein and the normal slot 324a of the first revolver 320 are aligned in the optical path, so that the incident light passes through the aperture 10 and the normal slot 324a in the optical path, such that the light is only converted by the aperture 10. While in the description of the present embodiment, the number of slots formed in the revolver is four, it is not limited thereto.

The first revolver 320 and the second revolver 340 have the same structure and function. Accordingly, by providing a detailed description on the structure of the second revolver 340 below, a description on the structure of the first revolver 320 is also included in the provided description of the second revolver 340.

Because an aperture 10 is not installed in the normal slot 344a, there are no restrictions to the shape and size of the normal slot 344a. Preferably, however, the normal slot 344a may be of a shape and size that will not affect the optical passage.

Apertures 10 are installed in the installing slots 344b. Therefore, a structure capable of securing the aperture 10 must be provided. Referring to FIG. 3, an installing slot 344b is recessed from the outer perimeter of the second revolver 340 toward the center of the second revolver 340, such that the installing slot 344b is formed in a wedge shape corresponding to the aperture 10 (to be described below). That is, the sectional area of the installing slot 344b gradually narrows toward the center of the second revolver 340. Alternately, as described below, the shapes of the aperture 10 and the installing slot 344b may be rectangular. These shapes do not affect the present invention overall.

A guide rail 345b is provided on the side walls of the installing slot 344b. The guide rail 345b guides the direction of movement of an aperture 10 that inserts into the installing slot 344b, and at the same time, prevents the aperture 10 inserted into the installing slot 344b from moving vertically.

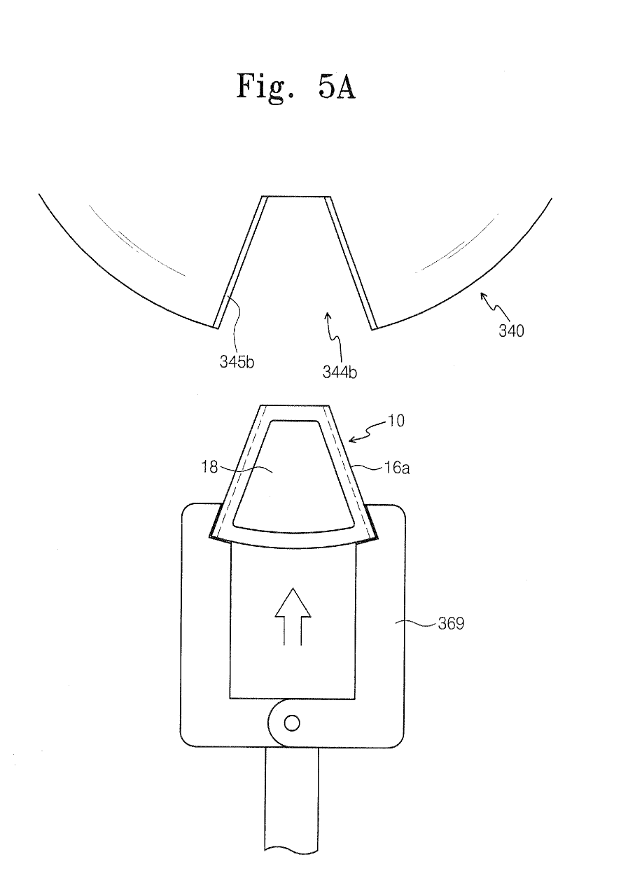

FIG. 4 is a perspective view of an aperture 10 according to the first embodiment of the present invention.

As described above, an aperture 10 performs the function of converting the shape of incident light to adjust the coherence factor. Light that passes through the aperture 10 is converted to annular, dipole, or quadrupole type light.

The aperture 10 is shaped as a wedge, and includes a front wall 12 that is disposed at the front when inserted into the installing slots 324b or 344b, a rear wall 14 parallel to the front wall 12, and two side walls 16 connecting the front wall 12 and the rear wall 14. An opening 18 is formed and enclosed by the front wall 12 and rear wall 14, and the two side walls 16. Various filters may be provided in the opening 18 to convert the shape of light. A guide slot 16a, into which the above-described guide rail 345b is inserted, is formed on the side walls 16. Alternately, the shape of the aperture 10 according to other embodiments of the present invention may be rectangular, without affecting the present invention overall.

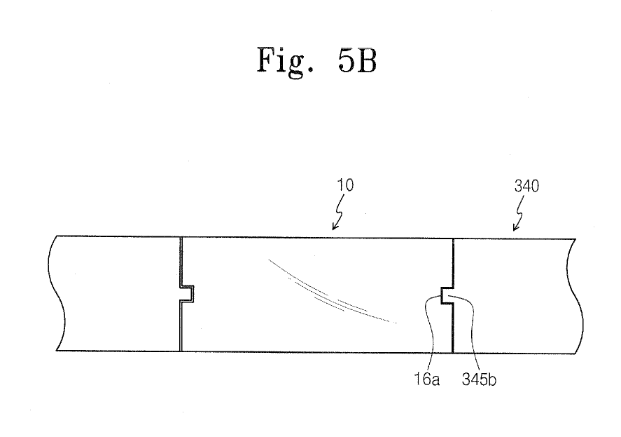

FIGS. 5a and 5b are a plan view and a side view showing the assembly of the revolver 340 in FIG. 3 and the aperture 10 in FIG. 4. Below, the process of installing an aperture 10 loaded on a cassette 380 to an installing slot 344b will be described.

An aperture 10 loaded on a cassette 380 is held by a hand 369, and is moved by first and second arms 366 and 368 to the installing slot 344b. Here, by elevating the drive shaft 364, the hand 369 may be moved to the height at which a desired aperture 10 is installed in a slot 382 (FIG. 2), so that the first and second arms 366 and 368 can pull the aperture 10 out from the slot 382.

The hand 369 holding the aperture 10 moves to the height of an installing slot 344b. Particularly, the hand 369 is moved to a height at which the guide rail 345b formed on the side wall of the slot 344b corresponds to a guide slot 16a of the aperture 10.

Next, as shown in FIG. 5a, the hand 369 is moved toward the center of the second revolver 340, and the aperture 10 is inserted into the installing slot 344b by sliding the guide slot 16a along the guide rail 345b. When the insertion is completed, the aperture 10 is installed in the installing slot 344b, as shown in FIG. 5b.

To remove the aperture 10 installed in the installing slot 344b, the reverse process (of which a detailed description will not be provided) of the installing process may be performed.

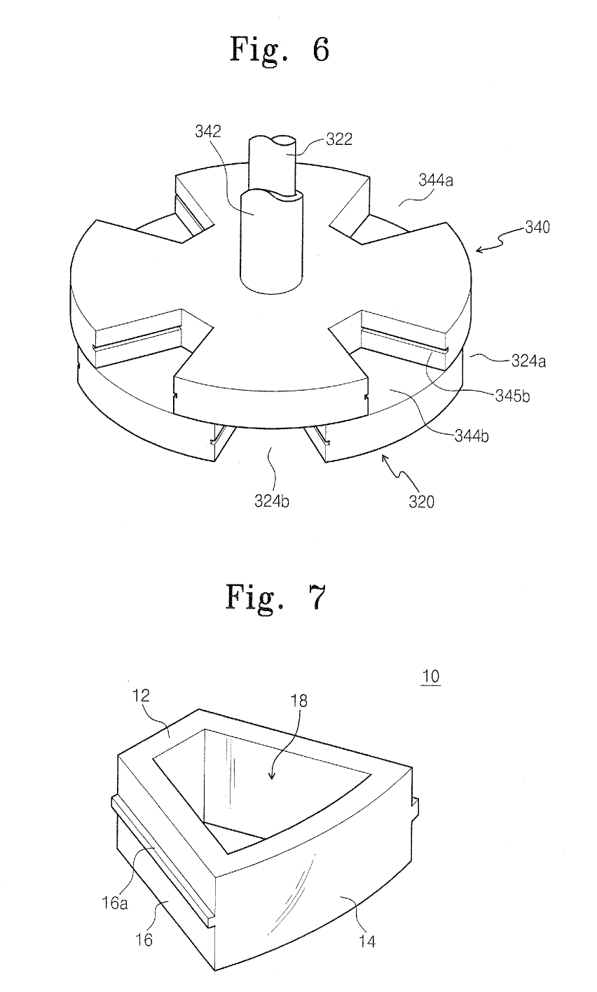

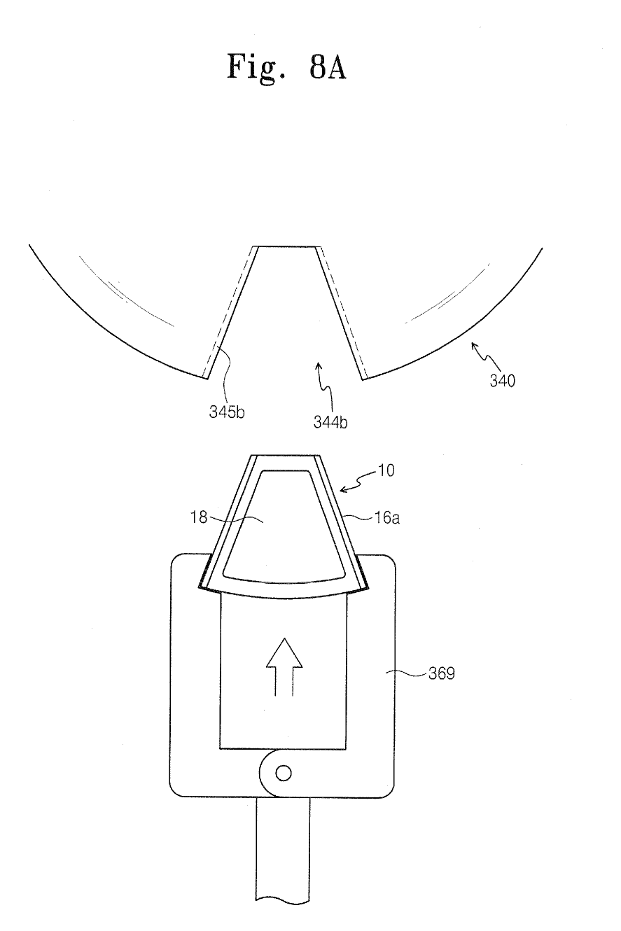

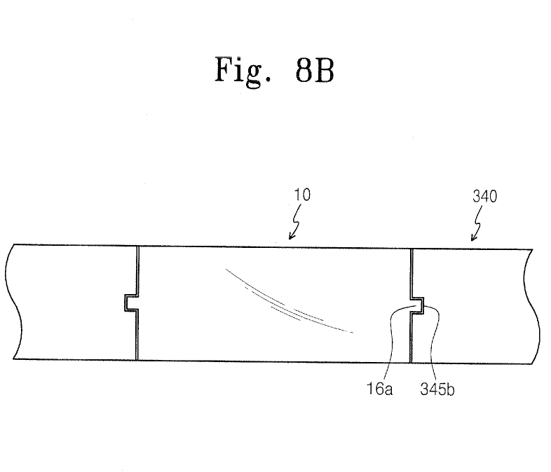

FIG. 6 is a perspective view of a revolver according to the second embodiment of the present invention, FIG. 7 is a perspective view of an aperture 10 according to the second embodiment of the present invention, and FIGS. 8a and 8b are a plan view and a side view showing the assembly of the revolver in FIG. 6 and the aperture 10 in FIG. 7.

Unlike in the above description, a guide slot 345b is provided on the side wall of the installing slot 344b, and a guide rail 16a is provided on the side wall 16 of the aperture 10. Here, the installing process of the aperture 10 in the installing slot 344b may be the same as the process described above, or different in that the aperture 10 is inserted onto the installing slot 344b by sliding the guide rail 16a provided on the aperture 10 along the guide slot 345b. When the insertion is complete, the aperture 10 is installed in the installing slot 344b, as shown in the diagrams.

As described above, by replacing apertures in installing slots, the process of replacing the first or second revolvers 320 or 340 does not have to be performed. Also, in order to replace an aperture 10, the aperture unit 300 does not have to be disassembled, and the conveying unit 360 may be used to replace an aperture 10 installed on a revolver with a new aperture 10 loaded on a cassette 380 within the housing 390.

The present invention allows an aperture in an optical path to be easily replaced with an aperture of a desired shape, so that the time required to replace apertures can be reduced.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An aperture unit comprising:
a cassette on which a plurality of apertures are loaded;
a revolver having a plurality of slots formed about a rotating axis of the revolver with the plurality of slots being configured to accept an aperture therein wherein the slots can be selectively rotated into alignment with an optical path; and
a conveying unit for conveying the apertures from the cassette and installing the apertures in the slots.

2. The aperture unit of claim 1, wherein the slots are recessed from an outer perimeter of the revolver toward a center of the revolver.

3. The aperture unit of claim 2, wherein the slots are wedge shaped.

4. The aperture unit of claim 2, wherein the slots are rectangular.

5. The aperture unit of claim 1, further including:
guide rails formed on side surfaces of the slots; and
guide slots formed on side surfaces of the apertures, wherein the apertures are installed in predetermined positions along the guide rails.

6. The aperture unit of claim 1, further including:
guide slots formed on side surfaces of the slots; and
guide rails formed on side surfaces of the apertures, wherein the apertures are installed in predetermined positions along the guide rails.

7. The aperture unit of claim 1, wherein the revolver comprises:
a first revolver having a plurality of first revolver slots formed about the axis of rotation; and
a second revolver mounted coaxially on the first revolver, and having a plurality of second revolver slots formed about the axis of rotation.

8. The aperture unit of claim 7, wherein the first revolver and the second revolver are independently rotatable about the axis of rotation.

9. The aperture unit of claim 8, wherein one of the first revolver slots and one of the second revolver slots are normal slots so that light is unconverted when passing therethrough.

10. The aperture unit of claim 9, further including:
guide rails formed on side surfaces of the slots; and
guide slots formed on side surfaces of the apertures, wherein the apertures are installed in predetermined positions along the guide rails.

11. The aperture unit of claim 9, further including:
guide slots formed on side surfaces of the slots; and
guide rails formed on side surfaces of the apertures, wherein the apertures are installed in predetermined positions along the guide rails.

12. The aperture unit of claim 1, further comprising a housing for isolating a moving path of the aperture from the cassette to the revolver from an outside, wherein the cassette, the revolver, and the conveying unit are provided within the housing.

13. An exposure system comprising:
a light source for emitting light;
an illumination part for transmitting the light emitted from the light source toward a reticle; and
a projection part for radiating light transmitted through the reticle onto a substrate loaded on a substrate stage; wherein
the illumination part includes an aperture unit for adjusting a coherence factor (σ) of incident light provided in an optical path, the aperture unit having:
a cassette on which apertures are loaded;
a revolver including a plurality of slots formed about a rotating axis of the revolver for installing the apertures respectively in, the revolver for rotating and selectively positioning the apertures in the optical path, and
a conveying unit for conveying the apertures from the cassette and installing the apertures in the slots.

14. The exposure system of claim 13, wherein the slots are recessed from an outer perimeter of the revolver toward a center of the revolver.

15. The exposure system of claim 13, further including:
guide rails formed on side surfaces of the slots;
guide slots, into which the guide rails are inserted, formed on side surfaces of the apertures; and
apertures installed in predetermined positions along the guide rails.

16. The exposure system of claim 13, wherein
guide slots formed on side surfaces of the slots;
guide rails, that are inserted into the guide slots, formed on side surfaces of the apertures; and
apertures installed in predetermined positions along the guide rails.

17. The exposure system of claim 13, further comprising a housing for isolating a moving path of the aperture from the cassette to the revolver from an outside, wherein the cassette, the revolver, and the conveying unit are provided within the housing.

18. The exposure system of claim 13, wherein the revolver of the aperture unit comprises:
a first revolver having a plurality of first revolver slots formed about the axis of rotation; and
a second revolver mounted coaxially on the first revolver, and having a plurality of second revolver slots formed about the axis of rotation.

19. A method for replacing an aperture installed on a rotatable revolver, the apertures disposed in an optical path, for converting incident light into various shapes according to a rotation of the revolver, the method comprising:
removing the aperture from the revolver using a conveying unit, and loading the removed aperture on a cassette with a plurality of other apertures; and
installing another of the plurality of other apertures loaded on the cassette onto the revolver, using the conveying unit.

20. The method of claim 19, further including providing a housing, wherein the cassette, the revolver, and the conveying unit are provided within the housing disposed in the optical path, and the housing isolates a moving path of the aperture.

21. The method of claim 19, further including inserting the aperture into a slot recessed from an outer circumference of the revolver toward a center of the revolver.

22. The method of claim 21, wherein the slot includes a guide rail formed on a side surface thereof, and the aperture includes a guide slot formed on a side surface thereof, the method further including receiving the guide rail within the guide slot to install the aperture into the slot.

23. The method of claim 21, wherein the slot includes a guide slot formed on a side surface thereof, the aperture includes a guide rail formed on a side surface thereof, the method further including sliding the guide rail of the aperture along the guide slot to install the aperture into the slot.

24. The method of claim 19, further including:
mounting a plurality of apertures about an axis of rotation of the revolver; and
rotating one of the plurality of apertures into the optical path.

25. The method of claim 19, wherein the revolver includes a first revolver and a second revolver, the method further including:
mounting a first plurality of apertures within the first revolver about an axis of rotation of the first revolver;
mounting a second plurality of apertures within the second revolver about an axis of rotation of the second revolver, the first axis of rotation and second axis of rotation being the same;
rotating the first revolver and the second revolver so that only a single aperture from one of the first or second revolvers and an normal space of the other of the first or second revolvers are interposed within the optical path.

26. An aperture unit for patterning light projected along an optical path onto a substrate, the aperture unit comprising:
a first revolver configured to have an axis of rotation off-axis to the optical path, the first revolver having a plurality of first revolver slots formed about the axis of rotation wherein the first revolver is rotatable so that a single one of the first revolver slots can be selectively interposed within the optical path;
a second revolver co-axial with the first revolver, the second revolver having a plurality of second revolver slots formed about the axis of rotation wherein the second revolver is rotatable independently of the first revolver so that a single one of the second revolver slots can be selectively interposed within the optical path;
first apertures installed in all but at least one of the slots of the first revolver; and
second apertures installed in all but at least one of the slots of the second revolver, wherein the first and second revolver can be rotated so that a single aperture from one of the first or second revolvers and an empty slot from the other of the first or second revolvers are simultaneously interposed within the optical path.

27. The aperture unit of claim 26, wherein the first revolver slots and the second revolver slots are wedge shaped.

28. The aperture unit of claim 27, wherein the apertures are coupled to the first revolver slots and second revolver slots by grooves and installing slots formed on side walls of the apertures, the first revolver slots, and the second revolver slots.

29. The aperture unit of claim 27, wherein each of the first and second revolvers include four slots.

30. The aperture unit of claim 26, wherein the first and second apertures are superimposed with a predetermined gap therebetween.

31. The aperture unit of claim 26, wherein:
the first revolver is connected at its upper surface to a first rotating shaft and the first revolver is rotated by the first rotating shaft;
the second revolver is connected at its upper surface to a second rotating shaft, and the second revolver is rotated by the second rotating shaft;
the second rotating shaft is a hollow shaft; and
the first rotating shaft is installed within the second rotating shaft.
